(19) United States
(12) Patent Application Publication
(10) Pub. No.: US 2014/0025355 A1
(43) Pub. Date: Jan. 23, 2014

(54) METHOD FOR EVALUATING THE POTENTIAL FOR HUMAN INFLUENCE OF GLOBAL TEMPERATURE AND CLIMATE PATTERNS

(71) Applicants: Charles D. Barton, Chicago, IL (US); Michael S. Carr, Dixon, IL (US)

(72) Inventors: Charles D. Barton, Chicago, IL (US); Michael S. Carr, Dixon, IL (US)

(21) Appl. No.: 13/946,889

(22) Filed: Jul. 19, 2013

Related U.S. Application Data
(60) Provisional application No. 61/673,656, filed on Jul. 19, 2012.

(51) Int. Cl. G06F 17/50

(52) U.S. Cl. CPC G06F 17/5009
USPC 703/2

(57) ABSTRACT

Embodiments relate to a method including assigning a relative or absolute per output unit weighting factor using a mathematical formulas based on individual and/or total sample population carbon sourcing.

### RELATED APPLICATIONS

This application claims the benefit of U.S. Provisional Application Ser. No. 61/673,656 filed Jul. 19, 2012, the complete subject matter of which is incorporated herein by reference in its entirety.

### FIELD OF THE INVENTION

The invention relates to generally to energy and renewable energy. More specifically embodiments of the present invention relate to a method, computer readable storage medium and a computer system for evaluating the relative carbon impact of participants in a given population s the ratio of Native (non-human introduced) vs. Non-native (human introduced) elemental carbon to track the potential for human influence of global temperature and climate patterns over time, alternatively a “Carbon Balance Index”.

### BACKGROUND OF THE INVENTION

Currently, the human influenced or non-natural introduction of Carbon into the atmosphere and its potential influence (+/−) on global temperature and/or weather patterns is an issue of great contention. One position argues that the human industrious combustion of fossil fuels and the resultant addition of non-natural gaseous carbon into the atmosphere is detrimental and as a result various complicated solutions have been contrived to address and/or correct this condition including punitive taxation, sequestration strategies, various methods of carbon accounting and even ‘environmental engineering’. The other position argues that the first position is alarmist and contrived and that the non-natural introduction of gaseous carbon has no ‘provable’ influence on global temperature and/or weather patterns and should be disregarded. This argument is problematic for three reasons: 1) without human industrious influence, CO2 and its various interactions within the global biosphere are known to be natural and necessary. 2) Collection and analysis of relevant data is complicated, imprecise and can be shown to support both positions. 3) This argument and all of the energies applied to it ‘may’ obscure a more fundamental and relevant point.

The method described herein is presented to simultaneously subvert the discussion and arguments about global warming and the role CO2 plays in it, while offering a socially unifying and financially index able goal based system to address the more fundamental and universally accepted idea that, regardless of what form it ultimately manifests itself, the human introduction of new or ‘non-native’ carbon as a usable energy source is less desirable than re-using or recycling existing ‘native’ carbon resources. The mechanism described herein is designed to be ‘fault agnostic’, to foster positive market forces to incentivize the discovery, facilitation, deployment and use of energy from renewable or re-cycled carbon sources and is derived from the following observations:

1. The atomic composition of earth and its atmosphere is generally static over the course of time, and remains independent of human-human and human-nature interactions. (i.e., The quantity of atoms of all elements in the system is generally unchanging over time);

2. “Carbon Accounting” is roughly possible understanding that it (carbon) exists in three fundamental forms: A) Inorganic Carbon (mineral carbon, e.g., Calcium Carbonate, etc.,) B) Organic Carbon (carbon existing in organisms), and C) Gaseous Carbon (CO2, CO, and CH4);

3. Carbon Pathways: It is understood that the transition of carbon from one form to another (or ‘Carbon Cycling”) happens through natural lithosphere/hydrosphere/atmosphere interactions and that without human industrious interference there are likely immeasurable natural fluctuations favoring one form over another over geologic time;

4. Gaseous Carbon: It is understood that the gaseous carbon relationship between the sun, the atmosphere, photosynthetic and non-photosynthetic organisms is complementary and natural, and that without human industrious interference it, too, may experience immeasurable natural fluctuations over time.

5. Carbon Control: It is understood that there are natural, periodic and intermittent processes aside from human industry that can influence the atmospheric gaseous carbon constituent profile, including: 1) Volcanic activity, 2) “Rock Weathering” and 3) Biological Activity.

It is concluded that with respect to the arguments regarding the potential effects of human introduced CO2 on global temperature and weather patterns, that the source of the carbon that the CO2 derives from is obviously more relevant, and a transition to energetic carbon transformations of entirely recycled origin obviates the entire argument and precludes the need for potentially catastrophic reactive measures like ‘environmental corrective engineering’.G

### SUMMARY OF THE INVENTION

Embodiments of the invention relate to a method including assigning a relative or absolute per output unit weighting factor using a mathematical formulas based on individual and/or total sample population carbon sourcing. One or more embodiments may include assessing of the impact of carbon addition to the environment based on the source of the carbon being emitted. Further embodiments may include the mathematical formula approximates the total non-atmospheric system sourced or non-native CO2 output of a population; the mathematical formula approximates the average non-native CO2 per output measure of a population; the mathematical formula approximates the total carbon output of a measured population; the mathematical formula approximates the per unit impact of an individual member of a measured population; the mathematical formula approximates the absolute individual total carbon impact value determination of a member of the measured population; and/or the mathematical formula approximates the relative individual total carbon impact value determination of a member of the measured population.

One embodiment relates to a computer readable storage medium containing one or more instructions, which when executed by a computer performs a method including assigning a relative or absolute per output unit weighting factor using a mathematical formulas based on individual and/or total sample population carbon sourcing. One or more embodiments may include assessing of the impact of carbon addition to the environment based on the source of the carbon being emitted. Further embodiments may include the mathematical formula approximates the total non-atmospheric system sourced or non-native CO2 output of a population; the mathematical formula approximates the average non-native CO2 per output measure of a population; the mathematical formula approximates the total carbon output of a measured population; the mathematical formula approximates the per unit impact of an individual member of a measured population; the mathematical formula approximates the absolute individual total carbon impact value determination of a member of the measured population; and/or the mathematical formula approximates the relative individual total carbon impact value determination of a member of the measured population.

Yet another embodiment relates to a computer system a computer readable storage medium containing one or more instructions, which when executed by a computer performs a method including assigning a relative or absolute per output unit weighting factor using a mathematical formulas based on individual and/or total sample population carbon sourcing. One or more embodiments may include assessing of the impact of carbon addition to the environment based on the source of the carbon being emitted. Further embodiments may include the mathematical formula approximates the total non-atmospheric system sourced or non-native CO2 output of a population; the mathematical formula approximates the average non-native CO2 per output measure of a population; the mathematical formula approximates the total carbon output of a measured population; the mathematical formula approximates the per unit impact of an individual member of a measured population; the mathematical formula approximates the absolute individual total carbon impact value determination of a member of the measured population; and/or the mathematical formula approximates the relative individual total carbon impact value determination of a member of the measured population.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### DETAILED DESCRIPTION OF PRESENTLY PREFERRED EMBODIMENTS

Embodiments of the present invention relate to energy and renewable energy. More particularly the invention relates to a method for evaluating the relative carbon impact of participants in a given population as the ratio of Native (non-human introduced) vs. Non-native (human introduced) elemental carbon to track the potential for human influence of global temperature and climate patterns over time, alternatively a “Carbon Balance Index”.

Discussion of Variables

Pₓₙ—P is used to denote a participant in the population being evaluated based on output unit type.

X—The X subscript is used to notationally divide the individuals by process type.

N—The N subscript is used to identify participating individuals within a process type.

Pₓₙ_{_{—}}_{rc}—This variable is the percentage of an individual process practitioner's' released carbon which is sourced from renewably sourced or ‘Native’ carbon consumption.

Pₓₙ_{_{—}}_{CO2}—This variable is the average CO2 released per output unit for an individual process practitioner without regard to carbon sourcing.

Pₓₙ_{_{—}}ₐₒ—This variable is the number of output units an individual process practitioner creates per year.

ΣP—This variable is the total number of individual process participants.

ΣPₐₒ—This variable is the total number of output units produced by all process participants.

Formula:

Total non-native CO2 output of population(T_{vCO2})=

Source 1% non-native carbon*Source 1 annual output units*Source 1 CO2 released per production unit+Source 2% non-native carbon*Source 2 annual output units*Source 2 CO2 released per production unit+ . . . +Source N % non-native carbon*Source N annual output units*Source N CO2 released per production unit

OR

((1−Pₓ₁_{_{—}}_{rc})*Pₓ₁_{_{—}}ₐₒ*P_{x1CO2})+((1−Pₓ₂_{_{—}}_{rc})*Pₓ₂_{_{—}}ₐₒ*P_{x2CO2})+ . . . +((1−Pₓₙ_{_{—}}_{rc})*Pₓₙ_{_{—}}ₐₒ*P_{xnCO2})

Example Series:

[((1−P_{c1}_{_{—}}_{rc})*P_{c1}_{_{—}}ₐₒ*P_{c1}_{_{—}}_{CO2})+((1−P_{c2}_{_{—}}ₐₒ)*P_{c2}_{_{—}}_{CO2})+ . . . +((1−P_{cn}_{_{—}}_{rc})*P_{cn}_{_{—}}ₐₒ*P_{cn}_{_{—}}_{CO2})+((1−Pₚ₁_{_{—}}_{rc})*Pₚ₁_{_{—}}ₐₒ*Pₚ₁_{_{—}}_{CO2})+((1−Pₚ₂_{_{—}}_{rc})*Pₚ₂_{_{—}}ₐₒ*Pₚ₂_{_{—}}_{CO2})+ . . . +(1−(Pₚₙ_{_{—}}_{rc})*Pₚₙ_{_{—}}ₐₒ*Pₚₙ_{_{—}}_{CO2})+((1−P_{g1}_{_{—}}_{rc})*P_{g1}_{_{—}}ₐₒ*P_{g1}_{_{—}}_{CO2})+((1−P_{g2} _{_{—}}_{rc})*P_{g2}_{_{—}}ₐₒ*P_{g2}_{_{—}}_{CO2})+ . . . +((1−P_{gn}_{_{—}}_{rc})*P_{gn}_{_{—}}ₐₒ*P_{gn}_{_{—}}_{CO2})+((1Pₒ₁_{_{—}}_{rc})*Pₒ₁_{_{—}}ₐₒ*Pₒ₁_{_{—}}_{CO2})+((1−Pₒ₂_{_{—}}_{rc})*Pₒ₂_{_{—}}ₐₒ*Pₒ₂_{_{—}}_{CO2})+ . . . +((1−Pₒₙ_{_{—}}_{rc})*Pₒₙ_{_{—}}ₐₒ*Pₒₙ_{_{—}}_{CO2})+((1−P_{w1}_{_{—}}_{rc})*P_{w1}_{_{—}}ₐₒ*P_{w1}_{_{—}}_{CO2})+((1−P_{w2}_{_{—}}_{rc})*P_{w2}_{_{—}}ₐₒ*P_{w2}_{_{—}}_{CO2})+ . . . +((1−P_{wn}_{_{—}}_{rc})*P_{wn}_{_{—}}ₐₒ*P_{wn}_{_{—}}_{CO2})+((1−Pₕ₁_{_{—}}_{rc})*Pₕ₁_{_{—}}ₐₒ*Pₕ₁_{_{—}}_{CO2})+((1−Pₕ₂_{_{—}}_{rc})*Pₕ₂_{_{—}}ₐₒ*Pₕ₂_{_{—}}_{CO2})+ . . . +((1−Pₕₙ_{_{—}}_{rc})*Pₕₙ_{_{—}}ₐₒ*Pₕₙ_{_{—}}_{CO2})+((1−Pₛ₁_{_{—}}_{rc})*Pₛ₁_{_{—}}ₐₒ*Pₛ₁_{_{—}}_{CO2})+((1−Pₛ₂_{_{—}}_{rc})*Pₛ₂_{_{—}}ₐₒ*Pₛ₂_{_{—}}_{CO2})+ . . . +((1−Pₛₙ_{_{—}}_{rc})*Pₛₙ_{_{—}}ₐₒ*Pₛₙ_{_{—}}_{CO2})+((1−Pₓ₁_{_{—}}_{rc})*Pₓ₁_{_{—}}ₐₒ*Pₓ₁_{_{—}}_{CO2})+((1−Pₓ₂_{_{—}}_{rc})*Pₓ₂_{_{—}}ₐₒ*Pₓ₂_{_{—}}_{CO2})+ . . . +((1−Pₓₙ_{_{—}}_{rc})*Pₓₙ_{_{—}}ₐₒ*Pₓₙ_{_{—}}_{CO2})]

Formula:

Average non-native CO2 released per output unit of total population(A_{vCO2})=

Source 1% non-native carbon*Source 1 annual output units*Source 1 CO2 released per production unit+Source 2% non-native carbon*Source 2 annual output units*Source 2 CO2 released per production unit+ . . . +Source N % non-native carbon*Source N annual output units*Source N CO2 released per production unit/total annual output units

OR

((1−Pₓ₁_{_{—}}_{rc})*Pₓ₁_{_{—}}ₐₒ*P_{x1CO2})+((1−Pₓ₂_{_{—}}_{rc})*Pₓ₂_{_{—}}ₐₒ*P_{x2CO2})+ . . . +((1−Pₓₙ_{_{—}}_{rc})*Pₓₙ_{_{—}}ₐₒ*P_{xnCO2})/ΣPₐₒ

OR

T_{vCO2}/Pₐₒ

Example Series:

[((1−P_{c1}_{_{—}}_{rc})*P_{c1}_{_{—}}ₐₒ*P_{c1}_{_{—}}_{CO2})+((1−P_{c2}_{_{—}}_{rc})*P_{c2}_{_{—}}ₐₒ*P_{c2}_{_{—}}_{CO2})+ . . . +((1−P_{cn}_{_{—}}_{rc})*P_{cn}_{_{—}}ₐₒ*P_{cn}_{_{—}}_{CO2})+((1−Pₚ₁_{_{—}}_{rc})*Pₚ₁_{_{—}}ₐₒ*Pₚ₁_{_{—}}_{CO2})+((1−Pₚ₂_{_{—}}_{rc})*Pₚ₂_{_{—}}ₐₒ*Pₚ₂_{_{—}}_{CO2})+ . . . +((1−Pₚₙ_{_{—}}_{rc})*Pₚₙ_{_{—}}ₐₒ*Pₚₙ_{_{—}}_{CO2})+((1−P_{g1}_{_{—}}_{rc})*P_{g1}_{_{—}}ₐₒ*P_{g1}_{_{—}}_{CO2})+((1−P_{g2}_{_{—}}_{rc})*P_{g2}_{_{—}}ₐₒ*P_{g2}_{_{—}}_{CO2})+ . . . +((1−P_{gn}_{_{—}}_{rc})*P_{gn}_{_{—}}ₐₒ*P_{gn}_{_{—}}_{CO2})+((1−Pₒ₁_{_{—}}_{rc})*Pₒ₁_{_{—}}ₐₒ*Pₒ₁_{_{—}}_{CO2})+((1−Pₒ₂_{_{—}}_{rc})*Pₒ₂_{_{—}}ₐₒ*Pₒ₂_{_{—}}_{CO2})+ . . . +((1−Pₒₙ_{_{—}}_{rc})*Pₒₙ_{_{—}}ₐₒ*Pₒₙ_{_{—}}_{CO2})+((1−P_{w1}_{_{—}}_{rc})*P_{w1}_{_{—}}ₐₒ*P_{w1}_{_{—}}_{CO2})+((1−P_{w2}_{_{—}}_{rc})*P_{w2}_{_{—}}ₐₒ*P_{w2}_{_{—}}_{CO2})+ . . . +((1−P_{wn}_{_{—}}_{rc})*P_{wn}_{_{—}}ₐₒ*P_{wn}_{_{—}}_{CO2})+((1−Pₕ₁_{_{—}}ₐₒ*Pₕ₁_{_{—}}_{CO2})+((1−Pₕ₂_{_{—}}_{rc})*Pₕ₂_{_{—}}ₐₒ*Pₕ₂_{_{—}}_{CO2})+ . . . +((1−Pₕₙ_{_{—}}_{rc})*Pₕₙ_{_{—}}ₐₒ*Pₕₙ_{_{—}}_{CO2})+((1−Pₛ₁_{_{—}}_{rc})*Pₛ₁_{_{—}}ₐₒ*Pₛ₁_{_{—}}_{CO2})+((1−Pₛ₂_{_{—}}_{rc})*Pₛ₂_{_{—}}ₐₒ*Pₛ₂_{_{—}}_{CO2})+ . . . +((1−Pₛₙ_{_{—}}_{rc})*Pₛₙ_{_{—}}ₐₒ*Pₛₙ_{_{—}}_{CO2})+((1−Pₓ₁_{_{—}}_{rc})*Pₓ₁_{_{—}}ₐₒ*Pₓ₁_{_{—}}_{CO2})+((1−Pₓ₂_{_{—}}_{rc})*Pₓ₂_{_{—}}ₐₒ*Pₓ₂_{_{—}}_{CO2})+ . . . +((1−Pₓₙ_{_{—}}_{rc})*Pₓₙ_{_{—}}ₐₒ*Pₓₙ_{_{—}}_{CO2})]/ΣPₐₒ

Formula:

Total CO2 output of population(T_{CO2})=Source 1 annual output units*Source 1 CO2 released per production unit+Source 2 annual output units*Source 2 CO2 released per production unit+ . . . +Source N annual output units*Source N CO2 released per production unit

OR

Pₓ₁_{_{—}}ₐₒ(Pₓ₁_{_{—}}_{CO2})+Pₓ₂_{_{—}}ₐₒ(Pₓ₂_{_{—}}_{CO2}), . . . , Pₓₙ_{_{—}}ₐₒ(Pₓₙ_{_{—}}_{CO2})

Example Series

P_{c1}_{_{—}}ₐₒ(P_{c1}_{_{—}}_{CO2})+P_{c2}_{_{—}}ₐₒ(P_{c2}_{_{—}}_{CO2})+ . . . +P_{cn}_{_{—}}ₐₒ(P_{cn}_{_{—}}_{CO2})+Pₚ₁_{_{—}}ₐₒ(Pₚ₁_{_{—}}_{CO2})+Pₚ₂_{_{—}}ₐₒ(Pₚ₂_{_{—}}_{CO2})+ . . . +Pₚₙ_{_{—}}ₐₒ(Pₚₙ_{_{—}}_{CO2})+P_{g1}_{_{—}}ₐₒ(P_{g1}_{_{—}}_{CO2})+P_{g2}_{_{—}}ₐₒ(P_{g2}_{_{—}}_{CO2})+ . . . +P_{gn}_{_{—}}ₐₒ(P_{gn}_{_{—}}_{CO2})+Pₒ₁_{_{—}}ₐₒ(Pₒ₁_{_{—}}_{CO2})Pₒ₂_{_{—}}ₐₒ(Pₒ₂_{_{—}}_{CO2})+ . . . +Pₒₙ_{_{—}}ₐₒ(Pₒₙ_{_{—}}_{CO2})+P_{w1}_{_{—}}ₐₒ(P_{w1}_{_{—}}_{CO2})+P_{w2}_{_{—}}ₐₒ(P_{w2}_{_{—}}_{CO2})+ . . . +P_{wn}_{_{—}}ₐₒ(P_{wn}_{_{—}}_{CO2})Pₕ₁_{_{—}}ₐₒ(Pₕ₁_{_{—}}_{CO2})Pₕ₂_{_{—}}ₐₒ(Pₕ₂_{_{—}}_{CO2})+ . . . +Pₕₙ_{_{—}}ₐₒ(Pₕₙ_{_{—}}_{CO2})+Pₛ₁_{_{—}}ₐₒ(Pₛ₁_{_{—}}_{CO2})+Pₛ₂_{_{—}}ₐₒ(Pₛ₂_{_{—}}_{CO2})+ . . . +Pₛₙ_{_{—}}ₐₒ(Pₛₙ_{_{—}}_{CO2})+Pₓ₁_{_{—}}ₐₒ(Pₓ₁_{_{—}}_{CO2})+Pₓ₂_{_{—}}ₐₒ(Pₓ₂_{_{—}}_{CO2})+ . . . +Pₓₙ_{_{—}}ₐₒ(Pₓₙ_{_{—}}_{CO2})

Formula:

Individual per unit CO2 impact value determination(Uₓₙ_{_{—}}_{CO2})=

(Source 1 CO2 released per production unit*Source 1% non-native carbon)−A_{vCO2},(Source 2 CO2 released per production unit*Source 2% non-native carbon)−A_{vCO2},(Source N CO2 released per production unit*Source N % non-native carbon)−A_{vCO2}

OR

(Pₓ₁_{_{—}}_{CO2}*(1−Pₓ₂_{_{—}}_{rc}))−A_{vCO2},(Pₓ₂_{_{—}}_{CO2}*(1−Pₓ₂_{_{—}}_{rc}))−A_{vCO2},(Pₓₙ_{_{—}}_{CO2}*(1−Pₓₙ_{_{—}}_{rc}))−A_{vCO2}

Example Series

(P_{c1}_{_{—}}_{CO2}*(1−P_{c1}_{_{—}}_{rc}))−A_{vCO2},(P_{c2}_{_{—}}_{CO2}*(1−P_{c2}_{_{—}}_{rc}))−A_{vCO2},(P_{cn}_{_{—}}_{CO2}*(1−P_{c2}_{_{—}}_{rc}))−A_{vCO2},(Pₚ₁_{_{—}}_{CO2}*(1−Pₚ₁_{_{—}}_{rc}))−A_{vCO2},(Pₚ₂_{_{—}}_{CO2}*(1−Pₚ₂_{_{—}}_{rc}))−A_{vCO2},(Pₚₙ_{_{—}}_{CO2}*(1−Pₚₙ_{_{—}}_{rc}))−A_{vCO2},(P_{g1}_{_{—}}_{CO2}*(1−P_{g1}_{_{—}}_{rc}))−A_{vCO2},(P_{g2}_{_{—}}_{CO2}*(1−P_{g2}_{_{—}}_{rc}))−A_{vCO2},(P_{gn}_{_{—}}_{CO2}*(1−P_{gn}_{_{—}}_{rc}))−A_{vCO2},(Pₒ₁_{_{—}}_{CO2}*(1−Pₒ₁_{_{—}}_{rc}))−A_{vCO2},(Pₒ₂_{_{—}}_{CO2}*(1−Pₒ₂_{_{—}}_{rc}))−A_{vCO2},(Pₒₙ_{_{—}}_{CO2}*(1−Pₒₙ_{_{—}}_{rc}))−A_{vCO2},(P_{w1}_{_{—}}_{CO2}*(1−P_{w1}_{_{—}}_{rc}))−A_{vCO2},(P_{w2}_{_{—}}_{CO2}*(1−P_{w2}_{_{—}}_{rc}))−A_{vCO2},(P_{wn}_{_{—}}_{CO2}*(1−P_{wn}_{_{—}}_{rc}))−A_{vCO2},(Pₕ₁_{_{—}}_{CO2}*(1−Pₕ₁_{_{—}}_{rc}))−A_{vCO2},(Pₕ₂_{_{—}}_{CO2}*(1−Pₕ₂_{_{—}}_{rc}))−A_{vCO2},(Pₕₙ_{_{—}}_{CO2}*(1−Pₕₙ_{_{—}}_{rc}))−A_{vCO2},(Pₛ₁_{_{—}}_{CO2}*(1−Pₛ₁_{_{—}}_{rc}))−A_{vCO2},(Pₛ₂_{_{—}}_{CO2}*(1−Pₛ₂_{_{—}}_{rc}))−A_{vCO2},(Pₛₙ_{_{—}}_{CO2}*(1−Pₛₙ_{_{—}}_{rc}))−A_{vCO2},(Pₓ₁_{_{—}}_{CO2}*(1−Pₓ₁_{_{—}}_{rc}))−A_{vCO2},(Pₓ₂_{_{—}}_{CO2}*(1−Pₓ₂_{_{—}}_{rc}))−A_{vCO2},(Pₓₙ_{_{—}}_{CO2}*(1−Pₓₙ_{_{—}}_{rc}))−A_{vCO2}

Formula:

Individual absolute CO2 impact value determination(IAₓₙ_{_{—}}_{CO2})=

Source 1 CO2 released per production unit*Source 1% non-native carbon,Source 2 CO2 released per production unit*Source 2% non-native carbon,Source N CO2 released per production unit*Source N % non-native carbon

OR

Pₓ₁_{_{—}}_{CO2}*(1−Pₓ₂_{_{—}}_{rc}),Pₓ₂_{_{—}}_{CO2}*(1−Pₓ₂_{_{—}}_{rc}),Pₓₙ_{_{—}}_{CO2}*(1−Pₓₙ_{_{—}}_{rc})

Example Series

P_{c1}_{_{—}}_{CO2}*(1−P_{c1}_{_{—}}_{rc}),P_{c2}_{_{—}}_{CO2}*(1−P_{c2}_{_{—}}_{rc}),P_{cn}_{_{—}}_{CO2}*(1−P_{c2}_{_{—}}_{rc}),Pₚ₁_{_{—}}_{CO2}*(1−Pₚ₁_{_{—}}_{rc}),Pₚ₂_{_{—}}_{CO2}*(1−Pₚ₂_{_{—}}_{rc}),Pₚₙ_{_{—}}_{CO2}*(1−Pₚₙ_{_{—}}_{rc}),P_{g1}_{_{—}}_{CO2}*(1−P_{g1}_{_{—}}_{rc}),P_{g2}_{_{—}}_{CO2}*(1−P_{g2}_{_{—}}_{rc}),P_{gn}_{_{—}}_{CO2}*(1−P_{gn}_{_{—}}_{rc}),Pₒ₁_{_{—}}_{CO2}*(1−Pₒ₁_{_{—}}_{rc}),Pₒ₂_{_{—}}_{CO2}*(1−Pₒ₂_{_{—}}_{rc}),Pₒₙ_{_{—}}_{CO2}*(1−Pₒₙ_{_{—}}_{rc}),P_{w1}_{_{—}}_{CO2}*(1−P_{w1}_{_{—}}_{rc}),P_{w2}_{_{—}}_{CO2}*(1−P_{w2}_{_{—}}_{rc}),P_{wn}_{_{—}}_{CO2}*(1−P_{wn}_{_{—}}_{rc}),Pₕ₁_{_{—}}_{CO2}*(1−Pₕ₁_{_{—}}_{rc}),Pₕ₂_{_{—}}_{CO2}*(1−Pₕ₂_{_{—}}_{rc}),Pₕₙ_{_{—}}_{CO2}*(1−Pₕₙ_{_{—}}_{rc}),Pₛ₁_{_{—}}_{CO2}*(1−Pₛ₁_{_{—}}_{rc}),Pₛ₂_{_{—}}_{CO2}*(1−Pₛ₂_{_{—}}_{rc}),Pₛₙ_{_{—}}_{CO2}*(1−Pₛₙ_{_{—}}_{rc}),Pₓ₁_{_{—}}_{CO2}*(1−Pₓ₁_{_{—}}_{rc}),Pₓ₂_{_{—}}_{CO2}*(1−Pₓ₂_{_{—}}_{rc}),Pₓₙ_{_{—}}_{CO2}*(1−Pₓₙ_{_{—}}_{rc})

Formula:

Individual relative CO2 impact value determination(IRₓₙ_{_{—}}_{CO2})=

Source 1 individual per unit CO2 impact value*Source 1 annual output units,Source 2 individual per unit CO2 impact value*Source 2 annual output units, . . . ,Source N individual per unit CO2 impact value*Source N annual output units

OR

Uₓ₁_{_{—}}_{CO2}*Pₓ₁_{_{—}}ₐₒ,Uₓ₂_{_{—}}_{CO2}*Pₓ₂_{_{—}}ₐₒ,Uₓₙ_{_{—}}_{CO2}*P_{Xn}_{_{—}}ₐₒ

Example Series

U_{c1}_{_{—}}_{CO2}*P_{c1}_{_{—}}ₐₒ,U_{c2}_{_{—}}_{CO2}*P_{c2}_{_{—}}ₐₒ,U_{cn}_{_{—}}_{CO2}*P_{cn}_{_{—}}ₐₒ,Uₚ₁_{_{—}}_{CO2}*Pₚ₁_{_{—}}ₐₒ,Uₚ₂_{_{—}}_{CO2}*Pₚ₂_{_{—}}ₐₒ,Uₚₙ_{_{—}}_{CO2}*Pₚₙ_{_{—}}ₐₒ,Uₒ₁_{_{—}}_{CO2}*Pₒ₁_{_{—}}ₐₒ,Uₒ₂_{_{—}}_{CO2}*Pₒ₂_{_{—}}ₐₒ,Uₒₙ_{_{—}}_{CO2}*Pₒₙ_{_{—}}ₐₒ,U_{w1}_{_{—}}_{CO2}*P_{w1}_{_{—}}ₐₒ,U_{w2}_{_{—}}_{CO2}*P_{w2}_{_{—}}ₐₒ,U_{wn}_{_{—}}_{CO2}*P_{wn}_{_{—}}ₐₒ,Uₕ₁_{_{—}}_{CO2}*Pₕ₁_{_{—}}ₐₒ,Uₕ₂_{_{—}}_{CO2}*Pₕ₂_{_{—}}ₐₒ,Uₕₙ_{_{—}}_{CO2}*Pₕₙ_{_{—}}ₐₒ,Uₛ₁_{_{—}}_{CO2}*Pₛ₁_{_{—}}ₐₒ,Uₛ₂_{_{—}}_{CO2}*Pₛ₂_{_{—}}ₐₒ,Uₛₙ_{_{—}}_{CO2}*Pₛₙ_{_{—}}ₐₒ,Uₓ₁_{_{—}}_{CO2}*Pₓ₁_{_{—}}ₐₒ,Uₓ₂_{_{—}}_{CO2}*Pₓ₂_{_{—}}ₐₒ,Uₓₙ_{_{—}}_{CO2}*Pₓₙ_{_{—}}ₐₒ

Example Model for Electricity

Before:

| | Units | | | | | |
|---|---|---|---|---|---|---|
| | | lb | | lb | | |
| | kwhr/yr | CO2/kwhr | | CO2/kwhr | | |
| | Pₓₙ_{_{—}}ₐₒ | Pₓₙ_{_{—}}_{CO2} | Pₓₙ_{_{—}}_{rc} | Uₓₙ_{_{—}}_{CO2} | IRₓₙ_{_{—}}_{CO2} | IAₓₙ_{_{—}}_{CO2} |
| NE | 81,500,000.00 | 1.827 | 0% | 0.75 | 61,224,185.50 | 148,900,500.00 |
| Coal 1 | | | | | | |
| (PC1) | | | | | | |
| NE | 40,750,000.00 | 1.835 | 0% | 0.76 | 30,938,092.75 | 74,776,250.00 |
| Coal 2 | | | | | | |
| (PC2) | | | | | | |
| NE | 40,750,000.00 | 1.82 | 0% | 0.74 | 30,326,842.75 | 74,165,000.00 |
| Coal 3 | | | | | | |
| (PC3) | | | | | | |
| NE | 57,000,000.00 | 2.156 | 0% | 1.08 | 61,572,369.00 | 122,892,000.00 |
| Petro 1 | | | | | | |
| (PP1) | | | | | | |
| NE | 57,000,000.00 | 2.156 | 0% | 1.08 | 61,572,369.00 | 122,892,000.00 |
| Petro 2 | | | | | | |
| (PP2) | | | | | | |
| NE | 57,000,000.00 | 2.145 | 0% | 1.07 | 60,945,369.00 | 122,265,000.00 |
| Perto 3 | | | | | | |
| (PP3) | | | | | | |
| NE | 57,000,000.00 | 2.167 | 0% | 1.09 | 62,199,369.00 | 123,519,000.00 |
| Petro 4 | | | | | | |
| (PP4) | | | | | | |
| NE Gas | 90,000,000.00 | 1.25 | 0% | 0.17 | 15,679,530.00 | 112,500,000.00 |
| 1 (PG1) | | | | | | |
| NE Gas | 45,000,000.00 | 1.3 | 0% | 0.22 | 10,089,765.00 | 58,500,000.00 |
| 2 (PG2) | | | | | | |
| NE Gas | 45,000,000.00 | 1.2 | 0% | 0.12 | 5,589,765.00 | 54,000,000.00 |
| 3 (PG3) | | | | | | |
| NE | 46,000,000.0 | 1.328 | 0% | 0.25 | 11,601,982.00 | 61,088,000.00 |
| Other | | | | | | |
| Fuel 1 | | | | | | |
| (PO1) | | | | | | |
| NE | 95,750,000.0 | 0 | 100% | −1.08 | −103,006,222.25 | 0 |
| Wind 1 | | | | | | |
| (PW1) | | | | | | |
| NE | 95,750,000.0 | 0 | 100% | −1.08 | −103,006,222.25 | 0 |
| Wind 2 | | | | | | |
| (PW2) | | | | | | |
| NE | 191,500,000.0 | 0 | 100% | −1.08 | −206,012,444.50 | 0 |
| Hydro | | | | | | |
| (PH1) | | | | | | |
| Total | 1,000,000,000.00 | | | | | |
| T_{vCO2} | 1,075,783,000 | | | | | |
| A_{vCO2} | 1.075783 | | | | | |
| T_{CO2} | 1,075,783,000 | | | | | |

After:

| | Units | | | | | |
|---|---|---|---|---|---|---|
| | | lb | | lb | | |
| | kwhr/yr | CO2/kwhr | | CO2/kwhr | | |
| | Pₓₙ_{_{—}}ₐₒ | Pₓₙ_{_{—}}_{CO2} | Pₓₙ_{_{—}}_{rc} | Uₓₙ_{_{—}}_{CO2} | IRₓₙ_{_{—}}_{CO2} | IAₓₙ_{_{—}}_{CO2} |
| NE | 81,500,000.00 | 1.827 | 25% | 0.51 | 41,817,089.69 | 111,675,375.00 |
| Coal 1 | | | | | | |
| (PC1) | | | | | | |
| NE | 40,750,000.00 | 1.835 | 0% | 0.98 | 39,847,107.34 | 74,776,250.00 |
| Coal 2 | | | | | | |
| (PC2) | | | | | | |
| NE | 40,750,000.00 | 1.82 | 100% | −0.86 | −34,929,142.66 | 0 |
| Coal 3 | | | | | | |
| (PC3) | | | | | | |
| NE | 57,000,000.00 | 2.156 | 0% | 1.30 | 74,034,058.13 | 122,892,000.00 |
| Petro 1 | | | | | | |
| (PP1) | | | | | | |
| NE | 57,000,000.00 | 2.156 | 50% | 0.22 | 12,588,058.13 | 61,446,000.00 |
| Petro 2 | | | | | | |
| (PP2) | | | | | | |
| NE | 57,000,000.00 | 2.145 | 0% | 1.29 | 73,407,058.13 | 122,265,000.00 |
| Perto 3 | | | | | | |
| (PP3) | | | | | | |
| NE | 57,000,000.00 | 2.167 | 25% | 0.77 | 43,781,308.13 | 92,639,250.00 |
| Petro 4 | | | | | | |
| (PP4) | | | | | | |
| NE Gas | 90,000,000.00 | 1.25 | 0% | 0.39 | 35,355,881.25 | 112,500,000.00 |
| 1 (PG1) | | | | | | |
| NE Gas | 45,000,000.00 | 1.3 | 25% | 0.12 | 5,302,940.63 | 43,875,000.00 |
| 2 (PG2) | | | | | | |
| NE Gas | 45,000,000.00 | 1.2 | 0% | 0.34 | 15,427,940.63 | 54,000,000.00 |
| 3 (PG3) | | | | | | |
| NE | 46,000,000.0 | 1.328 | 0% | 0.47 | 21,658,783.75 | 61,088,000.00 |
| Other | | | | | | |
| Fuel 1 | | | | | | |
| (PO1) | | | | | | |
| NE | 95,750,000.0 | 0 | 0% | −0.86 | −82,072,770.78 | 0 |
| Wind 1 | | | | | | |
| (PW1) | | | | | | |
| NE | 95,750,000.0 | 0 | 0% | −0.86 | −82,072,770.78 | 0 |
| Wind 2 | | | | | | |
| (PW2) | | | | | | |
| NE | 191,500,000.0 | 0 | 0% | −0.86 | 164,145,541.56 | 0 |
| Hydro | | | | | | |
| (PH1) | | | | | | |
| Total | 1,000,000,000.00 | | | | | |
| T_{vCO2} | 857,156,875 | | | | | |
| A_{vCO2} | 0.857156875 | | | | | |
| T_{CO2} | 857,156,875 | | | | | |

In one or more embodiments, the present invention includes a computer readable storage medium containing one or more instructions and a computer system containing such a computer readable storage medium, which when executed by the computer performs one or more of the methods provide above.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method comprising: assigning a relative or absolute per output unit weighting factor using a mathematical formulas based on individual and/or total sample population carbon sourcing.

2. The method of claim 1 further comprising assessing of the impact of carbon addition to the environment based on the source of the carbon being emitted.

3. The method of claim 1 wherein the mathematical formula approximates the total non-atmospheric system sourced or non-native CO2 output of a population.

4. The method of claim 1 wherein the mathematical formula approximates the average non-native CO2 per output measure of a population.

5. The method of claim 1 wherein the mathematical formula approximates the total carbon output of a measured population.

6. The method of claim 1 wherein the mathematical formula approximates the per unit impact of an individual member of a measured population.

7. The method of claim 1 wherein the mathematical formula approximates the absolute individual total carbon impact value determination of a member of the measured population.

8. The method of claim 1 wherein the mathematical formula approximates the relative individual total carbon impact value determination of a member of the measured population.

9. A computer readable storage medium containing one or more instructions, which when executed by a computer performs a method comprising:
assigning a relative or absolute per output unit weighting factor using a mathematical formulas based on individual and/or total sample population carbon sourcing.

10. The computer readable storage medium of claim 9 further comprising assessing of the impact of carbon addition to the environment based on the source of the carbon being emitted.

11. The computer readable storage medium of claim 9 wherein the mathematical formula approximates the total non-atmospheric system sourced or non-native CO2 output of a population.

12. The computer readable storage medium of claim 9 wherein the mathematical formula approximates the average non-native CO2 per output measure of a population.

13. The computer readable storage medium of claim 9 wherein the mathematical formula approximates the total carbon output of a measured population.

14. The computer readable storage medium of claim 9 wherein the mathematical formula approximates the per unit impact of an individual member of a measured population.

15. The computer readable storage medium of claim 9 wherein the mathematical formula approximates the absolute individual total carbon impact value determination of a member of the measured population.

16. The computer readable storage medium of claim 9 wherein the mathematical formula approximates the relative individual total carbon impact value determination of a member of the measured population.

17. In a computer system a computer readable storage medium containing one or more instructions, which when executed by a computer performs a method comprising:
assigning a relative or absolute per output unit weighting factor using a mathematical formulas based on individual and/or total sample population carbon sourcing.

18. The computer system of claim 17, the method further comprising assessing of the impact of carbon addition to the environment based on the source of the carbon being emitted.

19. The computer system of claim 17 wherein the mathematical formula approximates at least one of the total non-atmospheric system sourced or non-native CO2 output of a population; the average non-native CO2 per output measure of a population; the total carbon output of a measured population; the per unit impact of an individual member of a measured population; the absolute individual total carbon impact value determination of a member of the measured population and the relative individual total carbon impact value determination of a member of the measured population.
